(19) United States
(12) Patent Application Publication
(10) Pub. No.: US 2026/0300716 A1
(43) Pub. Date: Oct. 1, 2026

(54) AUTOMATED DATASET LABELING

(71) Applicant: PAYPAL, INC., San Jose, CA (US)

(72) Inventors: Yunfang Lu, Shanghai (CN); Shupeng Geng, Shanghai (CN); Ming Yuan, Shanghai (CN)

(21) Appl. No.: 19/227,182

(22) Filed: Jun. 3, 2025

Related U.S. Application Data
(63) Continuation of application No. PCT/CN2025/084606, filed on Mar. 25, 2025.

(51) Int. Cl. G06N 3/08; G06F 40/166; G06N 3/045

(52) U.S. Cl. CPC G06N 3/08; G06F 40/166; G06N 3/045

(57) ABSTRACT

A method includes generating a first set of coarse-grained labels, a first set of fine-grained labels, a second set of coarse-grained labels, and a second set of fine-grained labels. The first set of coarse-grained labels are generated by a first machine learning (ML) model and based on textual content and contextual information of each data point. The first set of fine-grained labels are generated by a second ML model and based on textual content and contextual information of each labeled data point. The second set of coarse-grained labels and the second set of fine-grained labels are generated by a third ML model and based on textual content and contextual information of each data point. The method also includes validating the subset of the input dataset based on comparisons of the first set of coarse-grained labels with the second set of coarse-grained labels and comparisons of the first set of fine-grained labels with the second set of fine-grained labels.

### CROSS-REFERENCE TO RELATED APPLICATIONS

The present disclosure is a continuation of International Application No. PCT/CN2025/084606, filed on Mar. 25, 2025, the entirety of which is incorporated by reference herein for all purposes.

### TECHNICAL FIELD

The present disclosure relates to machine learning and, more particularly, to automated dataset labeling for training machine learning models.

### BACKGROUND

Machine learning (ML) models can be trained using a labeled dataset, where each example (also referred to as a “sample” or “data point”) in the dataset is accompanied by a label (e.g., an annotation) that indicates the correct output (e.g., classification). For instance, in a dataset used to train a model to recognize images of dogs and cats, each image would be labeled as either “dog” or “cat”. The model trained on this labeled dataset using an algorithm that adjusts the model's parameters to minimize the difference between its predicted labels and the correct labels. Through this process, the model learns to recognize patterns in the data that are associated with each label and can eventually make predictions on new, unseen data. The size and quality of the labeled dataset can impact the training process, as a large and diverse dataset with accurate labels enables the model to learn and generalize to new situations.

### BRIEF DESCRIPTION OF THE DRAWINGS

Certain features of the subject technology are set forth in the appended claims. However, for the purpose of explanation, several embodiments of the subject technology are set forth in the following figures, where like reference numerals refer to the same or similar features in the various figures.

FIG. 1 is a block diagram of an example automated dataset labeling system, in accordance with one or more embodiments.

FIG. 2 is a process diagram of an example process for labeling a dataset and training a machine learning model, in accordance with one or more embodiments.

FIG. 3 is a block diagram of an example process for input data pre-processing, in accordance with one or more embodiments.

FIG. 4 is a process diagram of an example process for automatic labeling, in accordance with one or more embodiments.

FIG. 5 is a process diagram of an example process for quality control, in accordance with one or more embodiments.

FIG. 6 is a flow diagram of an example process for automated dataset labeling, in accordance with one or more embodiments.

FIG. 7 is a block diagram of an example computing system, in accordance with one or more embodiments.

### DETAILED DESCRIPTION

In data-driven applications, the quality and accuracy of labeled datasets contribute to the effectiveness of predictive models. Traditional dataset labeling techniques often involve manual annotation, which is labor-intensive, time-consuming, and prone to inconsistencies, especially when dealing with large-scale or multi-source datasets. The reliance on manual annotation also introduces subjectivity, leading to potential discrepancies in labels across different annotators.

In scenarios with hierarchical labels, such as customer service contact propensity prediction, labeling becomes more complex because data points may be assigned labels at multiple levels of granularity. The manual nature of this process not only slows down model development cycles but also increases operational costs and reduces scalability.

Additionally, dataset labeling may be continuously updated as new data emerges, making traditional methods inefficient in dynamically evolving environments. Without a robust and automated labeling mechanism, organizations may struggle with model drift, suboptimal predictions, and inefficient allocation of resources in customer service and other predictive analytics tasks.

Techniques of the present disclosure provide several technical advantages that directly address the challenges posed by traditional manual annotation methods. One of the benefits is scalability. Unlike manual labeling, which utilizes significant human effort and time, automated labeling can process large volumes of data at a much faster rate. This capability is useful in environments where data is continuously generated, such as customer service interactions, transaction records, or behavioral analytics. By leveraging automation, datasets can be kept up to date without bottlenecks, improving the responsiveness of predictive models to evolving patterns.

Another advantage is consistency in labeling. Manual annotation is prone to inconsistencies due to human subjectivity, especially when multiple annotators are involved. Automated labeling (e.g., using structured models such as large language models (LLMs) and ML classifiers), enables consistency in label assignment. This consistency may lead to higher-quality training datasets with reduced noise and ambiguities that could degrade model performance. Moreover, hierarchical labels can be applied systematically, enabling coarse-grained and fine-grained labels to be assigned with precision.

Another advantage is improved efficiency through reduced dependency on human expertise. While expert annotators may be used to define initial labeling rules and supervise quality control, the automation techniques described herein minimize the need for continuous human intervention. This reduces operational costs and allows human effort to focus on refining the labeling models rather than performing repetitive annotation tasks. Additionally, automated labeling can leverage pre-trained models to apply contextual understanding, enabling systems to label complex datasets with greater accuracy than rule-based or heuristic methods.

Automated dataset labeling also improves adaptability and model retraining. As new data flows into the system, automated methods can dynamically label incoming data, enabling models to continuously learn from fresh, annotated datasets. This adaptability helps mitigate model drift, where predictive performance deteriorates due to shifts in data distributions over time. With mechanisms like active learning, an automated labeling system can prioritize ambiguous or high-impact samples for human review, enabling the most informative data to be accurately labeled.

Lastly, automated labeling integrates quality control mechanisms to validate labeling accuracy. By incorporating multi-stage validation, such as leveraging a secondary high-accuracy model for validation, automated labeling systems can detect and correct errors more effectively than manual review alone. Sampling techniques enable strategic validation rather than exhaustive manual checking, making the process cost-efficient while maintaining high reliability. This structured validation framework improves the overall robustness of the dataset, leading to better model generalization and improved decision-making in downstream applications.

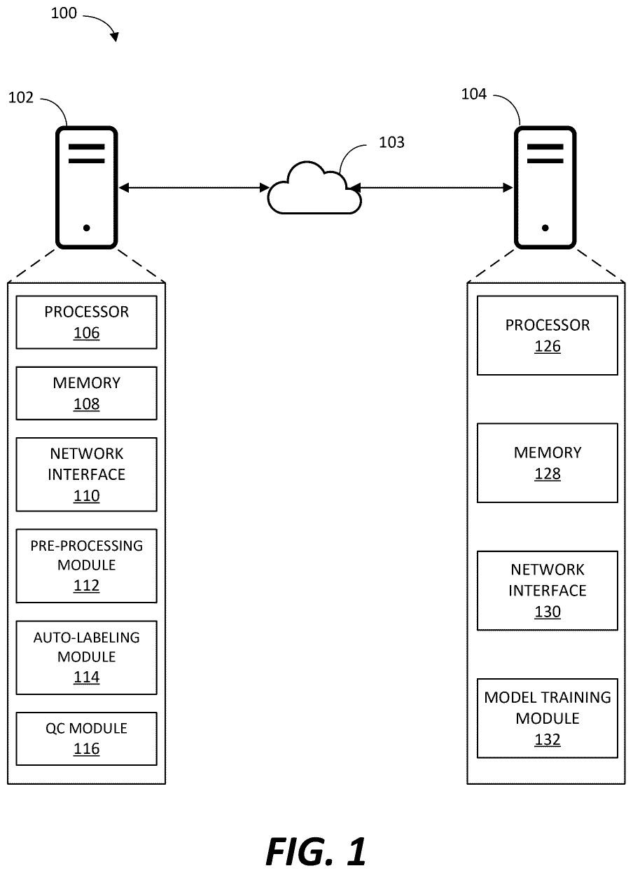

Referring now to the drawings, wherein like numerals refer to the same or similar features in the various figures, FIG. 1 is a block diagram of an example automated dataset labeling system 100, in accordance with one or more embodiments. Not all of the depicted components may be used in all embodiments, and one or more embodiments may include additional, fewer, or different components than those shown in the figure. Variations in the arrangement and type of components may be made without departing from the spirit or scope of the claims as set forth herein. Furthermore, the modules described with respect to the system 100 are used for convenience to refer to functionality that the system 100 is configured to perform by way of one or more components of the system 100 (e.g., computer-readable instructions in memory).

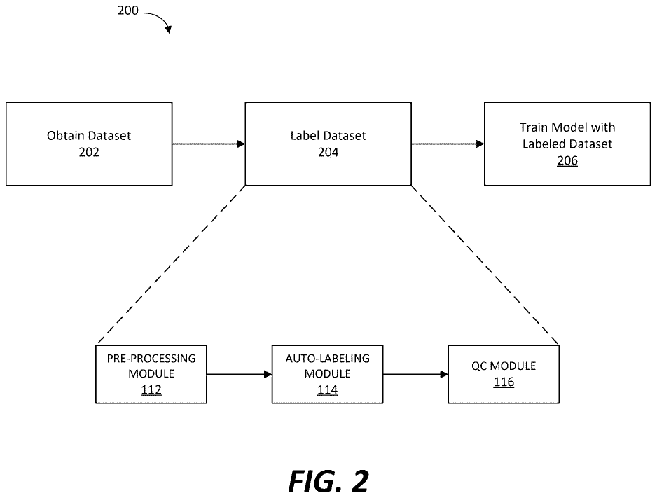

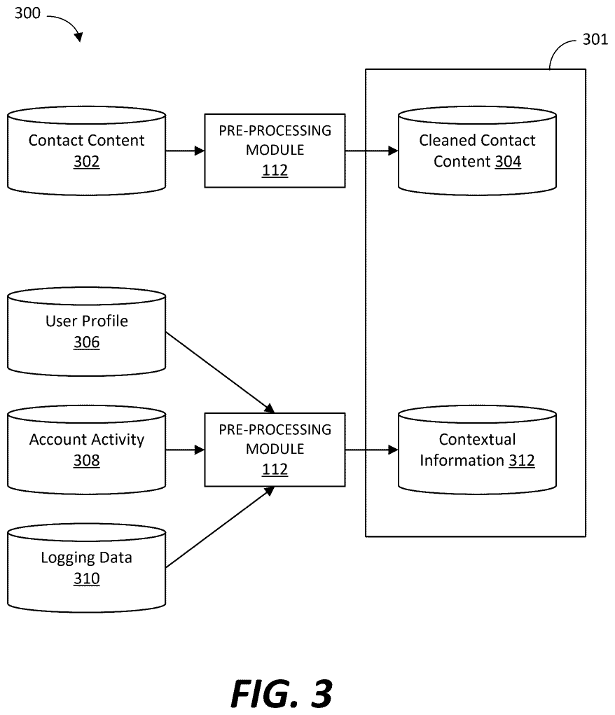

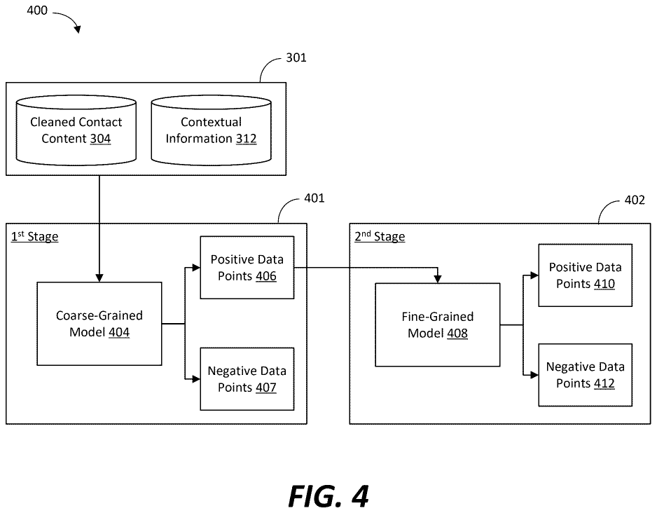

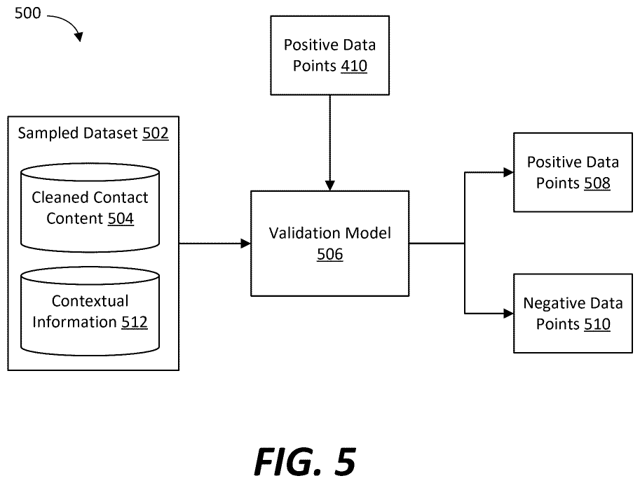

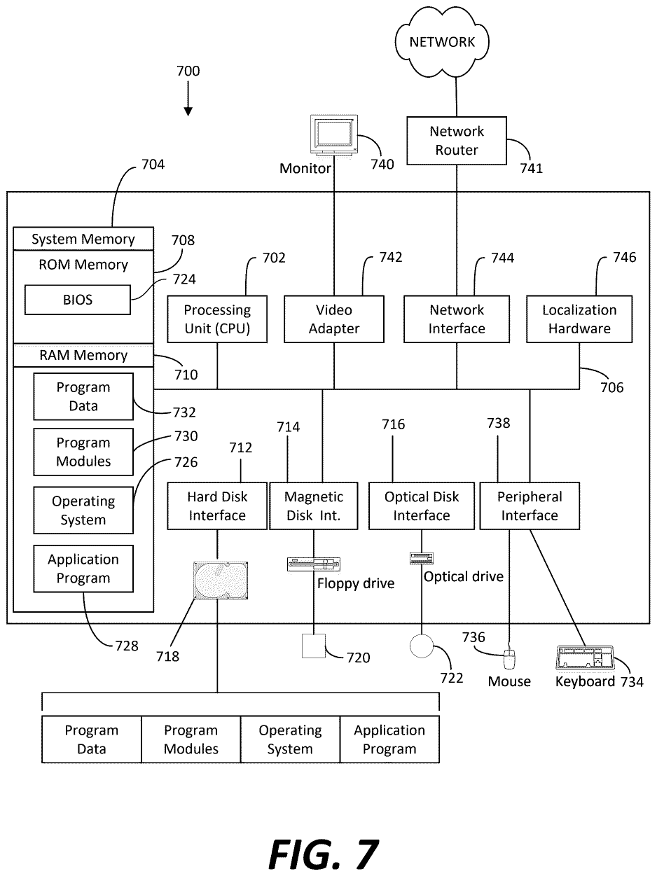

The system 100 may include a labeling server 102. The labeling server 102 may be or may include a computing device such as a server computer, desktop computer, tablet, smartphone, smartwatch, or any other physical or virtual computing device, such as a device having some or all of the components described with respect to FIG. 7. The network interface 110 (e.g., network interface card, cellular modem, etc.) enables the labeling server 102 to be in electronic communication with a training server 104 via a network 103. The labeling server 102 may include one or more functional modules 112, 114, 116, which may be embodied as hardware and/or software, such as software applications stored in memory 108 and run by the processor 106. The labeling server 102 includes a pre-processing module 112, auto-labeling module 114, and/or a QC module 116 (quality control module). The pre-processing module 112 includes hardware and/or software configured to collect and pre-process data to be used for input into an auto-labeling process, according to one or more algorithms described herein with respect to at least FIGS. 2 and 3. The auto-labeling module 114 includes hardware and/or software configured to generate one or more labels for data points in an input dataset in one or more stages, according to one or more algorithms described herein with respect to at least FIGS. 2 and 4. The QC module 116 includes hardware and/or software configured to generate one or more labels for at least some of the data points of the input dataset to validate the labels generated by the auto-labeling module 114, according to one or more algorithms described herein with respect to at least FIGS. 2 and 5.

The training server 104 may be or may include a computing device similar to the labeling server 102. The network interface 130 (e.g., network interface card, cellular modem, etc.) enables the training server 104 to be in electronic communication with the labeling server 102 via a network 103. The training server 104 may include one or more functional modules 132 embodied in hardware and/or software, such as software applications, which may be stored in memory 128 and run by the processor 126. The training server 104 includes model training module 132, which is configured to train one or more ML models with the auto-labeled dataset from the labeling server 102. Training ML models may be performed with supervised learning algorithms (e.g., linear regression, logistic regression, decision trees, random forests, and support vector machines), neural network algorithms (e.g., multilayer perceptrons, convolutional neural networks, and recurrent neural networks), K-nearest neighbors, naïve Bayes, gradient boosting, and/or the like.

The network 103 may communicatively (directly or indirectly) couple the labeling server 102 and the training server 104. In one or more embodiments, the network 103 may be an interconnected network of computing devices that may include, or may be communicatively coupled to, the Internet. For explanatory purposes, the network environment is illustrated in FIG. 1 as including the labeling server 102 and the training server 104; however, the network environment may include any number of computing devices communicatively coupled to each other via the network 103.

In operation, the processor 106 may obtain data from memory 108, 128 and pre-process the data to form an unlabeled training dataset. To label the training dataset, the unlabeled training dataset may be provided to the auto-labeling module 114 to be automatically labeled in a multi-stage process. To confirm that the automatic labels are useful for training purposes, at least some of the training dataset may be separately labeled in a quality control (QC) process. A comparison between the labeled training dataset from the multi-stage process and the labeled training dataset from the QC may determine whether the labels and/or the models used for automatic labeling need human intervention and/or whether the labeled training dataset can be sent to the training server 104 (e.g., via network 103 and network interfaces 110, 130) for the model training module 132 to train a machine learning model. In some embodiments, the server 102 may use the labeled dataset to train an ML model.

With the labeled training dataset, the local server 102 and/or remote server 104 may use the labeled training dataset to train a model for contact propensity prediction, for example, where user behavior is used to determine a likelihood of whether the user will contact customer support within a period of time after a specified event. For instance, a trained propensity model may be deployed to customer support centers to predict the likelihood that a customer will contact customer support within 24 hours after a payment decline.

FIG. 2 is a process diagram of an example process 200 of labeling a dataset and using the labeled dataset to train an machine learning model, in accordance with one or more embodiments. For explanatory purposes, FIG. 2 is described herein with reference to the system 100 of FIG. 1, and thus the process 200 may be a computer-implemented method. However, this is merely illustrative, and features of the system 100 may be performed by any other system for implementing the subject technology. Additionally, for explanatory purposes, the operations of the process 200 are described herein as occurring sequentially or linearly. However, multiple operations of the process 200 may occur in parallel. The operations of the process 200 need not be performed in the order shown, and one or more operations of the process 200 need not be performed or can be replaced by other operations.

The automatic labeling process 200 follows a structured process designed to efficiently generate labeled datasets for ML models. The process 200 includes operation 202 (obtaining the dataset), operation 204 (labeling the dataset), and operation 206 (training a model with the labeled data).

Operation 202 includes collecting raw data from relevant sources. Depending on the application, the data may include structured information (e.g., transaction records, user profiles, log files) and/or unstructured content (e.g., customer-agent conversations, emails, text reviews). The dataset may be gathered locally from memory 108 and/or from local and/or remote databases, APIs, or live streams. For example, the dataset may include data from local customer support databases, which include transcripts of previous user calls with customer support, and transaction APIs, which can securely provide the status of user transactions from remote databases.

Operation 204 includes multiple steps to systematically label the data while providing efficiency and accuracy. Operation 204 may include pre-processing (e.g., with the pre-processing module 112) raw data to prepare it for labeling. Pre-processing may include, for example, cleaning text-based data by removing noise (e.g., filler words, HTML tags, irrelevant phrases, etc.), structuring metadata (e.g., user details, account activity, transaction logs, etc.) into a format that is usable for downstream processing, normalizing and filtering data points to remove inconsistencies and improve label quality, transforming tabular data (e.g., into structured narratives or embeddings if necessary for language models), handling missing values, and/or any other suitable pre-processing techniques.

Operation 204 also includes processing the data through a multi-stage auto-labeling process (e.g., the auto-labeling module 114). The auto-labeling process includes a first-stage labeler, where the data is input to an LLM that assigns coarse-grained labels based on predefined categories, and a second-stage labeler, where the data and coarse label are input to a smaller model or domain-specific classifier that refines the labels by applying fine-grained categorization. The auto-labeling models may operate based on pre-trained knowledge, custom prompts, and/or learned patterns from a seed dataset, making the auto-labeling process efficient and scalable.

Operation 204 also includes validating and/or refining the automatically assigned labels (e.g., with the QC module 116). The QC module 116 may include a model independent from the auto-labeling module 114, such as a more advanced LLM or a model trained with human-verified labels, which acts as a validation system. Accordingly, validating and/or refining may include inputting at least some of the data and the refined labels to the validating model, which may generate and output a confirmation of the labels and/or an indication that one or more labels are inaccurate. In some embodiments, quality control may include sampling the labeled data set and inputting the samples, rather than the entire labeled data set, to the validating model, making the process cost-effective while maintaining high accuracy. If discrepancies are detected between the auto-labeling process and the QC process, the auto-labeling models may be iteratively improved to reduce errors over time.

Once the dataset has been labeled and validated, the dataset may be used to train an ML model at operation 206. Depending on the application, the model could be a classification model, a deep learning network, a mixture of experts (MOE) architecture that processes different modalities of input data, and/or any other suitable model. As new data becomes available, the auto-labeling process can continuously update and refine the dataset, allowing the trained model to remain adaptive to changing patterns.

FIG. 3 is a block diagram of an example process 300 for input data pre-processing, in accordance with one or more embodiments. For explanatory purposes, the figure is described with reference to the system 100 of FIG. 1 and thus the process 300 may be a computer-implemented method. However, this is merely illustrative, and features of the system 100 may be performed by any other system for implementing the subject technology.

The process 300 may include inputting raw data included in contact content 302, user profile data 306, account activity data 308, and/or logging data 310 into the pre-processing module 112 to clean the raw data, structure the raw data, and/or enrich the raw data with contextual information, before the data enters the input dataset 301. Pre-processing enhances data quality, reduces noise, and/or optimizes input formatting for models like LLMs or ML classifiers. Pre-processing includes contact content cleaning and/or contextual information generation.

Raw contact content 302, such as user conversations, interaction logs, and transaction-related messages, may include noise that can mislead ML models. Accordingly, the pre-processing module 112 may pre-process the contact content 302 by removing or transforming uninformative text elements so that relevant information can be processed. The pre-processing module 112 may also perform noise filtering, text normalization, and/or redundant data removal on the raw contact content 302 to form cleaned contact content 304.

Conversations often include disfluencies, typos, and extraneous symbols that do not contribute to meaningful label assignments. For example, filler words, hesitation markers, and extended pauses in text-based chat logs may be removed. So, if a raw data point includes “Auh... I was trying to . . . umm . . . make a payment, but it didn't go through . . . uh . . . what should I do?”, a cleaned version may include “I was trying to make a payment, but it didn't go through. What should I do?”. Noise filtering may include removing hesitation markers to make the content more structured for classification. Additionally, extraneous symbols such as excessive punctuation, emojis, or incorrectly formatted HTML tags from web-based chats may be removed. For example, the pre-processing module 112 may include regular expressions, rule-based text parsers, or other pattern-matching algorithms to identify and remove hesitation markers and extraneous symbols.

Text normalization may provide consistency in textual data, particularly when different variations of the same phrase are used. This may include converting abbreviations and slang into standard forms (e.g., “thx” to “thanks”), standardizing casing (e.g., by converting text to lowercase), fixing spelling errors, etc. For instance, a user message saying, “Plz help! My txn gt declned!” may be normalized to “Please help! My transaction got declined!” to improve model interpretability. To perform text normalization, the pre-processing module 112 may include abbreviation or slang dictionaries to map informal terms to formal terms and spelling correction algorithms (e.g., edit-distance-based algorithms or pre-trained spell-checking models) to identify and replace misspelled words with their formal spelling.

Redundant data removal may include removing elements in a conversation that do not contribute to meaningful classification. Such elements include greetings and closings (e.g., “hello, how are you?” and “thank you for your help, goodbye.”), automated system messages (e.g., “your chat session has started”), acknowledgment phrases (e.g., “got it” and “okay”). The pre-processing module 112 may include rule-based or machine-learning-based algorithms for text segmentation, which identifies conversational elements such as greetings, closings, and acknowledgment phrases. Automated system messages may be removed through keyword detection or metadata tags associated with system-generated content.

In addition to generating cleaned contact content 304, the pre-processing module 112 may also generate contextual information 312 by aggregating and structuring relevant user profile data 306, account activity data 308, and/or logging data 310, in some embodiments, as described below. Contextual information may enhance the dataset for certain ML tasks like user contact propensity modeling. For example, the pre-processing module 112 may apply statistical analysis or frequency-based filtering to highlight significant patterns, such as recurring transaction failures or frequent agent interactions.

The pre-processing module 112 may extract metadata from user profile data 306 to provide richer context for labeling. Such metadata may include attributes such as geographic location, device type used, and user segment classification. For instance, a dataset entry might include information indicating that a user from the U.S. attempted a transaction on a desktop computer, providing valuable context that could influence customer support contact propensity modeling.

Similarly, account activity data 308 may be collected to give insight into recent actions performed by the user before initiating contact. This could involve analyzing transaction history, prior declined payments, or account modifications. If a user has repeatedly attempted payments within a short timeframe before contacting support, this pattern may indicate a recurring issue with a particular payment method. The pre-processing module 112 may summarize and/or structure the account activity data 308 in structured formats, such as JSON objects or tabular representations, the labeling model can incorporate these signals effectively. An example of a structured data entry might be:
{“user_country”: “US”, “device_type”: “Desktop”, “recent_account_activity”: “Multiple failed payment attempts within 24 hours”}

Additionally, logging data 310 (e.g., from user-agent interactions) provides another layer of context, offering details on how the issue was handled during the support interaction. This may include tracking support agent actions, such as whether the support agent approved an override for a declined payment, provided troubleshooting steps, or escalated the case to a specialized team. Additionally, system logs capturing error messages encountered by the user (e.g., “transaction declined due to risk system blocking”) can help classify the root cause of the problem more precisely. If a user interaction log includes an error code corresponding to fraud detection, it can be automatically associated with a relevant fine-grained label in the dataset. The pre-processing module 112 may summarize and/or structure the logging data 310 in structured formats, such as JSON objects or tabular representations, the labeling model can incorporate the data more effectively.

In some embodiments, the structured data may be embedded into natural language summaries using a large language model rather than performing raw metadata integration. Instead of maintaining separate categorical fields, metadata can be transformed into a descriptive text format that enhances interpretability by other LLMs. For example, a structured representation of contextual information could be converted into: “User from the U.S. using a desktop attempted multiple transactions within 24 hours and received a risk-related decline error before contacting support.” The pre-processing module 112 may generate the natural language summaries by formatting the structured metadata into a structured prompt that causes the LLM to use its pretrained knowledge to synthesize the input data into a natural language description. This approach enables the labeling model to process metadata in a format similar to contact content, making it more adaptable for LLMs.

Although contact content 302 is described herein as user-related text data in user support situations, it should be understood that contact content 302 may be any kind of data of any modality that is to be labeled. Similarly, although contextual information 312 is described herein as user-related metadata in user support situations, it should be understood that contextual information 312 may be any kind of metadata of any modality that can be used to provide context to data that is to be labeled.

FIG. 4 is a process diagram of an example process 400 for automatic labeling, in accordance with one or more embodiments. For explanatory purposes, the figure is described with reference to the system 100 of FIG. 1 and thus the process 400 may be a computer-implemented method. However, this is merely illustrative, and features of the system 100 may be performed by any other system for implementing the subject technology. Additionally, for explanatory purposes, the operations of the process 400 are described herein as occurring sequentially or linearly. However, multiple operations of the process 400 may occur in parallel. The operations of the process 400 need not be performed in the order shown, and one or more operations of the process 400 need not be performed or can be replaced by other operations.

The process 400 may be performed by the auto-labeling module 114 in multiple stages. The first labeling stage 401 in the auto-labeling process 400 involves assigning coarse-grained labels to data points, providing an initial categorization of data points. The first labeling stage 401 uses a coarse-grained model 404, such as an LLM, to assign each data point (e.g., having contact content 304 and contextual information 312) in the input dataset 301 a coarse-grained label. The coarse-grained label distinguishes a data point between interactions that are relevant to a category (e.g., positive data points 406) and those that are not (e.g., negative data points 407). In the context of user contact propensity prediction, for example, the coarse-grained model 404 is trained and/or prompted to identify whether a conversation pertains to a payment decline event, a transaction failure, or another predefined high-level category. The coarse-grained labels help segment the input dataset 301 into broad categories so that the subsequent labeling stage can focus on more detailed distinctions.

To accomplish this, the auto-labeling module 114 may prompt the coarse-grained model using a structured input format. The auto-labeling module 114 may prompt the coarse-grained model 404 by providing the coarse-grained model 404 with natural language instructions about the task, defining each category explicitly, and/or supplying a sample conversation or metadata-rich entry for classification. A prompt may include the following:
You are an AI assistant tasked with classifying customer service interactions into broad categories based on the content of the conversation and relevant metadata. The possible categories are:
Payment Decline: The customer reports that a payment could not be processed.
Transaction Failure: The customer attempted a transaction that did not go through, but the issue is not directly related to a payment decline.
Account Verification: The customer is facing verification issues related to login, security checks, or account authentication.
General Inquiry: The customer is asking a question unrelated to payments, transactions, or verification.
The conversation transcript and metadata are provided below:
Customer: “I tried making a payment yesterday, but it was declined. Can you help?”
Metadata: {“user_country”: “US”, “device_type”: “Mobile”, “recent_account_activity”: “Attempted payment at 3:15 PM, declined due to risk rules.”}
Classify this interaction into one of the above categories and output the label.

The output of the first labeling stage 401 may include positive data points 406 and negative data points 407. Positive data points 406 are those that match the defined categories and will proceed to the second labeling stage 402 for further refinement. For instance, if a conversation explicitly mentions a failed payment attempt followed by a user inquiry, the model 404 may categorize it as “payment decline,” marking it as a positive data point for further analysis. Other high-level categories, such as “transaction failure” or “whitelist request” (where a user requests approval to bypass a system restriction), may also be similarly labeled so that all meaningful transaction-related interactions are captured.

Negative data points 407, on the other hand, are data points that do not fall within the scope of the defined categories. These may include general inquiries unrelated to payment issues, technical support questions about non-transactional topics, or user interactions that do not indicate any service failure. The model 404 may assign these cases to an “other” category, effectively filtering them out from the next stage of auto-labeling. By doing so, the labeling process prevents irrelevant data from being processed further, reducing computational costs and helping the fine-grained model 408 focus only on refining data points that contribute to the specific predictive model being developed.

To improve model recall, in some embodiments, the auto-labeling module 114 may prompt the model 404 to focus on a particular label (e.g., payment decline) along with other labels that have similar semantic meanings with the particular label (e.g., transaction failure, transaction attempt declines, etc.). For example, a prompt with alternative phrasing may include the following:
You are a text classifier in an NLP task. Given a user utterance, you need to classify it into the specific categories including payment decline, transaction failure, transaction attempt decline, or other categories according to the content of the conversation data and other metadata.
The following part enclosed between %%% are the definitions for each of the categories.
%%%
Payment decline: this refers to a situation where a user cannot make the payment and the payment is declined.
Transaction failure: this refers to a situation where a user cannot make a transaction.
Transaction attempt decline: this refers to a situation where a user tries to make a transaction but fails.
Whitelist to go through the payment process: this refers to a scenario where the user's transaction records are in the whitelist so that he can go on with the payment process.
Other categories: not related to payment decline, transaction failure, or transaction attempt decline.
%%%
You are to give one or more labels mentioned above in the output.
The output labels should reflect the topic or main points in the conversation.

In some embodiments, the model 404 may be a fine-tuned domain-specific classification model. Rather than relying solely on a pre-trained LLM's broad linguistic understanding, a fine-tuned model (e.g., trained on manually labeled data) can be deployed for more accurate classification.

The second labeling stage 402 includes refining the coarse-grained labeling by applying fine-grained labeling to the filtered dataset (e.g., positive data points 406). This stage builds on the coarse-grained labels by introducing more specific sub-labels that capture the underlying reasons for the data sample being classified. A goal of this stage includes enhancing the granularity of dataset labeling so that the ML models trained on this dataset can distinguish between subtle variations in user interactions.

The second labeling stage 402 includes a fine-grained model 408, which may be a smaller and more specialized classifier than the coarse-grained model 404 (e.g., LLM) used in the first labeling stage 401. Unlike the coarse-grained model 404, which assigns labels according to broad categories, the fine-grained model is configured to assign labels for detailed attributes within a broad category.

The smaller size of the fine-grained model 408 may refer to its reduced computation complexity, narrower scope, and/or more specialized function. Unlike the coarse-grained model 404, which may be an LLM capable of handling a wide range of general classifications, the fine-grained model 408 may be configured to process only a subset of the filtered data (e.g., positive data points 406), making it more lightweight and efficient. The fine-grained model 408 can be implemented using a deep learning model, such as a transformer-based classifier fine-tuned on labeled training data, or another form of ML model such as a support vector machine (SVM) or decision tree that has been trained to distinguish between fine-grained labels.

The fine-grained model 408 may differ from the coarse-grained model 404 in its level of specificity and/or in the data it processes. The coarse-grained model 404 may perform general filtering so that relevant data points are passed to the fine-grained model 408(e.g., positive data points 406). In contrast, the fine-grained model 408 may operate on data that has already been identified as belonging to a particular high-level category. For example, if a conversation was labeled as “payment decline” in the first labeling stage 401, the fine-grained model 408 may determine the reason behind the decline, such as “due to risk system blocking,” “insufficient funds,” or “bank authorization failure” in the second labeling stage 402.

To achieve this, the fine-grained model 408 may process the contact content 304 (e.g., textual content) and contextual information 312 (e.g., metadata) of a data point in the positive data points 406. While the coarse-grained model 404 generates a label based on conversation transcripts and a broad context, the fine-grained model 408 may specifically incorporate structured information such as transaction logs, error codes, and system-generated messages. For instance, if a payment was declined and the system logs show an error message stating, “Transaction blocked due to suspected fraud,” the model 408 can correctly assign the fine-grained label “due to risk system blocking.”

The output of the fine-grained model 408 includes positive data points 410 and negative data points 412. Positive data points 410 are those that receive a subcategory label, which may be directly used in model training. For example, if a dataset is being developed to predict whether a user will contact support due to a fraud-related payment block, data points labeled as “due to risk system blocking” may be positive training examples. The positive data points 410 provide clear signals for training predictive models to recognize similar patterns in future interactions.

Negative data points 412 in the second labeling stage 402 may be handled differently than in the first labeling stage 401. Since the dataset 301 has already been filtered for relevance, negative data points 412 may not be discarded but may instead be categorized as easy or hard negatives. Easy negatives include data points where the interaction was labeled as “payment decline” in the first stage but does not contain sufficient signals to assign a fine-grained label. These can be excluded from further processing. Hard negatives, on the other hand, include data points where the fine-grained model 408 initially assigned an incorrect fine-grained label, such as misclassifying a “bank authorization failure” as “risk system blocking.” The negative data points 412 may be reintroduced for active learning or human review to refine future auto-labeling accuracy.

In some embodiments, the fine-grained model 408 has a mixture of experts (MOE) architecture where multiple specialized neural networks (experts) are trained to handle different parts of the dataset 301. In this case, each expert network may specialize in distinguishing fine-grained subcategories within the broader classification categories. A gating mechanism (e.g., another neural network) may dynamically select which expert(s) should process a given data point based on, for example, the type of data. The fine-grained model 408 may have an expert for tabular data, text data, sequential data, numerical data, audio data, and/or the like.

The transformer-based architecture in the MOE model allows it to leverage attention mechanisms to process sequential input data more effectively. Transformers may be suitable for tasks involving natural language processing (NLP), such as analyzing user-agent conversations, transaction logs, and contextual metadata. The self-attention mechanism enables the fine-grained model 408 to capture dependencies between words and phrases, identifying features that distinguish between different transaction failure types. For instance, in a conversation where a user states, “My bank declined the transaction even though I have enough balance,” the attention mechanism can highlight the term “bank declined” as a cue for classification.

In some embodiments, hierarchical label embedding may bias the models during attention weight calculation in the feedforward process of training and/or inference. Hierarchical label embeddings encode the relationships between coarse-grained and fine-grained labels as vector representations. Hierarchical embeddings may capture semantic similarities between labels so that related categories influence each other during classification. For example, the label “transaction failure” may share latent similarities with “payment decline” and “bank authorization failure,” while being more distinct from “account suspension” or “billing inquiry.” By embedding this hierarchical structure into the transformer-based MOE model, the system can leverage label dependencies as an additional bias term in the attention mechanism.

FIG. 5 is a process diagram of an example process 500 for quality control, in accordance with one or more embodiments. For explanatory purposes, the figure is described with reference to the system 100 of FIG. 1 and thus the process 500 may be a computer-implemented method. However, this is merely illustrative, and features of the system 100 may be performed by any other system for implementing the subject technology. Additionally, for explanatory purposes, the operations of the process 500 are described herein as occurring sequentially or linearly. However, multiple operations of the process 500 may occur in parallel. The operations of the process 500 need not be performed in the order shown, and one or more operations of the process 500 need not be performed or can be replaced by other operations.

The process 500 may be performed by the QC module 116. The QC module 116 verifies that the labels assigned during the auto-labeling stage (e.g., with process 400) are accurate and reliable for downstream ML applications. Since the automated labeling processes involve multi-stage classification, errors may arise at different levels, leading to potential misclassifications or inconsistencies in the dataset 301. The QC module 116 may mitigate these issues by implementing a validation mechanism that evaluates the correctness of the labeled dataset before it is used for downstream ML applications (e.g., model training).

The QC module 116 includes a validation model 506, which may be an independent, higher-accuracy evaluator that cross-checks the labels assigned by the auto-labeling process with the labels generated by itself. Unlike the auto-labeling models, which may be configured for speed and efficiency, the validation model 506 may be more powerful and configured for accuracy and stability. The validation model 506 may be a larger, more advanced LLM, which may be configured to act as a quality assurance mechanism via fine-tuning and/or prompting.

The validation model 506 may operate by generating labels for at least part of the dataset 301 and comparing the labels to those produced by the auto-labeling process. Since validating every data point in a large dataset is computationally expensive, in some embodiments, a sampling strategy is used to select a representative portion of the dataset for review. The sampling process may capture a diverse set of data points so that common and uncommon labeling cases are evaluated.

Once a sampled dataset 502 is formed (e.g., by sampling the dataset 301), the validation model 506 independently assigns labels to the data points of the sampled dataset 502 by processing the cleaned contact content 504 (e.g., conversation transcripts) and contextual information 512 (e.g., metadata) of the data points. The validation model 506 may follow one or more structured prompts that define the classification task, which may include the classification tasks of the coarse-grained model 404 and/or the fine-grained model 408.

The output of the validation model 506 includes positive data points 508 and negative data points 510. Positive data points 508 include data points from the sampled dataset 502 where the assigned label from the validation model 506 matches the auto-labeled result, confirming that the auto-labeling is accurate. The validated labels associated with the positive data points 508 may increase confidence in the dataset and can be directly incorporated into the final training set for downstream ML applications (e.g., training). Additionally, labels associated with the positive data points 508 can be used to further fine-tune the auto-labeling models (coarse-grained model 404 and/or fine-grained model 408), reinforcing their ability to make accurate predictions.

Negative data points 510, on the other hand, include data points from the sampled dataset 502 where the label generated by the validation model 506 is different than the label generated by the auto-labeling process. The negative data points 510 may be flagged for further inspection, either through human review or iterative model refinement. In some embodiments, the negative data points 510 may be used to retrain the auto-labeling models on the negative data points 510 to improve their performance over time.

In some embodiments, the process 500 also incorporates metrics to quantify auto-labeling performance. The proportion of mismatches between the validation model 506 and the auto-labeling process may be tracked as a performance indicator. If the mismatch rate exceeds a predefined threshold, the QC module 116 may signal for further refinement in the auto-labeling process 400. Additionally, error analysis can reveal whether misclassifications are concentrated in certain label categories in the auto-labeling process 400, indicating weaknesses in a model's ability to distinguish between closely related classes.

Once the validation model 506 generates its own labels for the sampled data points, the validation model 506 compares its labels against the labels assigned by the auto-labeling process (e.g., the positive data points 410) to validate their accuracy (e.g., identify discrepancies between the two sets of labels).

To validate the accuracy of the auto-labeled dataset, the validation model 506 may perform a direct label comparison for the coarse-grained labels and/or fine-grained labels with its labels. If the label assigned by the auto-labeling process matches the label generated by the validation model 506 (e.g., the labels of positive data points 410 match the labels of positive data points 508), the data point may be considered validated. However, if a mismatch occurs (e.g., where the validation model 506 assigns a different label than the auto-labeling process), the data point may be flagged for further analysis. These discrepancies help identify systematic errors, such as misclassification of certain label types, inconsistencies in labeling similar data points, or biases introduced by the training data of the auto-labeling models.

In some embodiments, for a more nuanced evaluation, the validation model 506 also calculates agreement metrics between its labels and the auto-labeling process labels. A metric in this validation process may include the agreement rate, which measures the percentage of sampled data points where both sets of labels are the same. A high agreement rate (e.g., above a predetermined agreement rate threshold) may indicate that the auto-labeling process is functioning reliably, while a lower agreement rate (e.g., below a predetermined agreement rate threshold) may indicate that refinements (e.g., in the auto-labeling models) are needed.

In some embodiments, the validation model 506 may identify disagreement patterns, analyzing whether specific labels or label pairs frequently result in mismatches. For example, if the auto-labeling process often misclassifies “risk system blocking” as “bank authorization failure,” this pattern can be flagged for targeted model adjustments.

Flags may be markers used to highlight potential labeling issues, inconsistencies, and/or ambiguities. When the validation model 506 detects a discrepancy between its generated label and the auto-labeled label, the validation model 506 may assign a flag to signal the need for further review or correction. One kind of flag is the label mismatch flag, triggered when the validation model 506 and auto-labeling process produce different labels for the same data point. The label mismatch flag may indicate potential misclassifications, such as those due to semantic confusion or overgeneralization. Another kind of flag is the low-confidence flag, which may be used when the auto-labeling model assigns a label with low certainty. The low-confidence flag may prioritize cases for review to prevent weak labels from contaminating the dataset. Another kind of flag is the inconsistent label flag, which may be used when similar data points receive different labels. The inconsistent label flag may signal issues in a model's decision-making process.

Flags may support active learning by identifying areas where the auto-labeling models could be improved. Frequently flagged data points can be isolated, reviewed, and used to retrain the model, refining its accuracy. Additionally, flags can trigger human intervention when automated validation fails, allowing manual efforts to focus on the more pressing errors rather than performing exhaustive dataset verification.

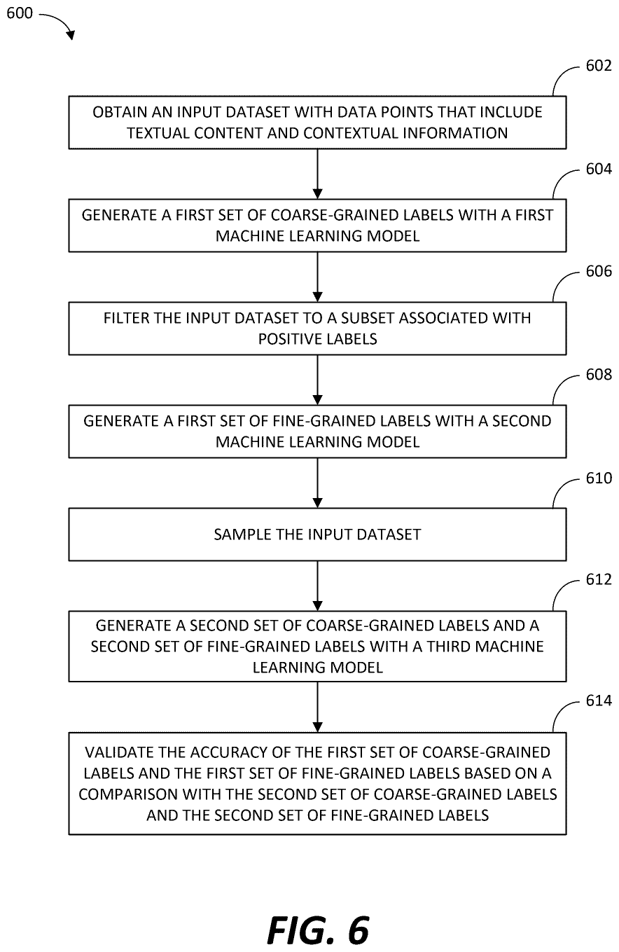

FIG. 6 is a flow diagram of an example process 600 for automated dataset labeling, in accordance with one or more embodiments. For explanatory purposes, the figure is described with reference to the system 100 of FIG. 1 and thus the process 600 may be a computer-implemented method. However, this is merely illustrative, and features of the system 100 may be performed by any other system for implementing the subject technology. Additionally, for explanatory purposes, the operations of the process 600 are described herein as occurring sequentially or linearly. However, multiple operations of the process 600 may occur in parallel. The operations of the process 600 need not be performed in the order shown, and one or more operations of the process 600 need not be performed or can be replaced by other operations.

At operation 602, the pre-processing module 112 obtains (e.g., accesses, downloads, receives, etc.) an input dataset (e.g., input dataset 301) with data points that include textual content (e.g., cleaned contact content 304) and contextual information (e.g., contextual information 312). The textual content may be based on a user interaction (e.g., chat or phone call with a support agent) associated with a data point. The contextual information may include user account activity, such as location, device type, recent activity, logging data, etc.

In some embodiments, obtaining the input dataset includes pre-processing the input dataset. Pre-processing the data may include normalizing the textual content of each data point and/or transforming the contextual information into a structured format (e.g., JSON). Pre-processing tabular data may include converting the tabular data into a paragraph of data analysis description by an LLM. If the tabular data includes description statements with the numerical data, the description statements may be the context of the numerical tabular data and provided to the LLM along with the numerical tabular data to help generate a more accurate data analysis description from the tabular data.

At operation 604, the auto-labeling module 114 generates (e.g., at a first labeling stage 401) a first set of coarse-grained labels (e.g., associated with the positive data points 406) with a first machine learning model (e.g., coarse-grained model 404). The first ML model (e.g., an LLM) may be configured (e.g., trained and/or prompted) to assign a coarse-grained label to each of the data points given the textual content and the contextual information of each data point as input to the first ML model. The auto-labeling module 114 may provide, or the first ML model may include, a prompt that defines a labeling task and includes one or more positive labels (e.g., transaction failure) and/or one or more negative labels (e.g., other categories). In some embodiments, the positive labels may share a semantic meaning (e.g., payment decline, transaction failure, and transaction attempt decline) in order to improve the recall of the first ML model.

At operation 606, the auto-labeling module 114 filters (e.g., sorts, arranges, categorizes, etc.) the input dataset 301 to data points associated with positive labels (e.g., positive data points 406) and/or data points associated with negative labels (e.g., negative data points 407). In some embodiments, the positive label may be a predetermined category and the negative label may be any category that is not a predetermined category. In some embodiments, the data points associated with negative labels may be used to re-train the first ML model.

At operation 608, the auto-labeling module 114 generates (e.g., at a second labeling stage 402) a first set of fine-grained labels (e.g., associated with positive data points 410) with a second ML model (e.g., fine-grained model 408). The second ML model may be a neural network configured (e.g., trained) to assign a fine-grained label to each of the one or more data points associated with positive labels (e.g., positive data points 406).

In some embodiments, the second ML model includes one or more expert models for generating the first set of fine-grained labels. Each of the one or more expert models may be configured (e.g., trained) to generate a fine-grained label for a particular data type.

In some embodiments, the first ML model is larger than the second ML model. The size of an ML model may be based on its parameter count, computation complexity, scope, and/or the like. For example, the first ML model may include more parameters than the second ML model.

The first set of fine-grained labels and the first set of coarse-grained labels may have a hierarchical relationship. That is, the coarse-grained labels may relate to one or more categories and the fine-grained labels may relate to one or more narrower sub-categories corresponding to a particular category.

In some embodiments, the hierarchical relationship between the first set of coarse-grained labels and the first set of fine-grained labels is represented as hierarchical label embeddings. The hierarchical label embeddings encode the relationship between coarse-and fine-grained labels as structured vector representations. The hierarchical embeddings may be a bias term in the fine-grained model's transformer-based architecture, influencing attention weight calculation during training and/or inference. For example, the hierarchical bias may help guide the fine-grained model from a “payment decline” coarse-grained label toward related subcategories like “risk system blocking” or “insufficient funds” rather than unrelated labels. This hierarchical bias improves classification accuracy, reduces errors caused by ambiguous inputs, and enhances generalization for underrepresented labels by enabling information sharing across related categories.

At operation 610, the QC module 116 samples the input dataset (e.g., dataset 301). The QC module 116 strategically samples the data points in the input dataset to balance validation accuracy with computational efficiency. The QC module 116 may sample data points with coarse-grained labels and/or fine-grained labels together or separately. The QC module 116 may sample data points with coarse-grained labels and/or fine-grained labels with the same or different selection criteria.

This sampled subset (e.g., sampled dataset 502) of the input dataset may include high-frequency labels and low-frequency labels so that the QC model can effectively assess labeling consistency across the possible labels. In some embodiments, data points with high uncertainty (e.g., those that were assigned multiple possible labels or an uncertain label) are prioritized for validation, as these cases are more likely to contain errors.

The sampling process may distinguish between data points with coarse-grained labels and fine-grained labels. Since the coarse-grained labels represent broader categories, a smaller proportion of these data points (~1-2% of the input dataset) may be sampled, as errors at this level may be less frequent but more impactful when they do occur. For fine-grained labels, a higher proportion (~5% of the input dataset) may be sampled, including labels associated with rare but significant failure types. Additionally or alternatively, fine-grained labels that frequently appear in misclassified cases of the auto-labeling process may be given higher sampling priority so that the most problematic labels are continuously re-evaluated and improved.

In some embodiments, the QC module 116 may use an uncertainty-based sampling approach to optimize sampling by leveraging the confidence scores associated with each label. If an auto-labeling model assigns a label with a confidence score below a predetermined confidence score threshold, the corresponding data points may be flagged (e.g., selected) for QC validation. This approach helps the sampling process work on ambiguous cases where the auto-labeling process may be struggling to distinguish between closely related labels.

In some embodiments, the QC module 116 may use a diversity-based sampling approach, where data points are selected to include broad coverage of different user interaction types, transaction contexts, and other metadata conditions, rather than based on label uncertainty or frequency.

In some embodiments, the QC module 116 may use an active learning sampling approach, which integrates feedback from previous validation cycles. In this approach, once an error pattern is identified (e.g., a systemic misclassification between two fine-grained labels), the QC module automatically increases the sampling rate for similar data points in subsequent iterations. This adaptive approach refines the QC stage over time, continuously improving the auto-labeling process by emphasizing areas where errors are most prevalent.

At operation 612, the QC module 116 uses the sampled data points to generate a second set of coarse-grained labels and a second set of fine-grained labels (e.g., associated with sampled dataset 502) with a third machine learning model (e.g., validation model 506). Once the data points are sampled, the QC model processes them independently to generate labels (e.g., positive data points 508 and negative data points 510) that serve as a validation benchmark for the auto-labeled dataset (e.g., positive data points 406 and/or positive data points 410). Unlike the auto-labeling models that are configured for efficiency and scalability, the QC model is configured for accuracy and interpretability so that its labels are more reliable. For example, the QC model may have more parameters than the auto-labeling models.

The QC model generates labels by reprocessing each sampled data point, analyzing its contact content and contextual metadata without relying on the labels previously assigned by the auto-labeling process. This independent evaluation reduces bias from the other models influencing the validation process. The QC model may be prompted with a structured set of classification instructions, similar to those used in the auto-labeling process. For example, the prompt may define the label hierarchy, provide examples of correct and incorrect labeling, and/or instruct the model to explain its decision-making process when necessary.

At operation 614, the QC module 116 validates the accuracy of the first set of coarse-grained labels and the first set of fine-grained labels based on a comparison with the second set of coarse-grained labels and the second set of fine-grained labels. Data points associated with labels from the auto-labeling module 114 that are in agreement with labels from the QC module 116 may be used for downstream use (e.g., training an ML model) and/or to retrain one or more of the models of the auto-labeling module 114. Data points associated with labels from the auto-labeling module 114 that are in disagreement with labels from the QC module 116 may manually reviewed and used to retrain one or more of the models of the auto-labeling module 114.

FIG. 7 is a block diagram of an example computing system 700. A computing system 700 may be a desktop computer, laptop, smartphone, tablet, or any other electronic device having the ability to execute instructions, such as those stored within a non-transitory computer-readable medium. Furthermore, while described and illustrated in the context of a single computing system 700, those skilled in the art will also appreciate that the various tasks described hereinafter may be practiced in a distributed environment having multiple computing systems 700 linked via a local-or wide-area network in which the executable instructions may be associated with and/or executed by one or more of multiple computing systems 700.

In its most basic configuration, the computing system 700 may include at least one processing unit 702 and at least one memory 704, which may be linked via a bus 706. Depending on the exact configuration and type of computing system environment, memory 704 may be volatile (such as RAM 710), non-volatile (such as ROM 708, flash memory, etc.) or some combination of the two.

Computing system 700 may have additional features and/or functionality. For example, computing system 700 may also include additional storage (removable and/or non-removable) including, but not limited to, magnetic or optical disks, tape drives and/or flash drives. Such additional memory devices may be made accessible to the computing system 700 by means of, for example, a hard disk drive interface 712, a magnetic disk drive interface 714, and/or an optical disk drive interface 716. As will be understood, these devices, which may be linked to the system bus 706, respectively, allow for reading from and writing to a hard drive 718, reading from or writing to a removable magnetic disk 720, and/or for reading from or writing to a removable optical disk 722, such as a CD/DVD ROM or other optical media. The drive interfaces and their associated computer-readable media may allow for the non-volatile storage of computer-readable instructions, data structures, program modules and other data for the computing system 700. Those skilled in the art will further appreciate that other types of computer-readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer-readable (e.g., computer-implemented) instructions, data structures, program modules or other data. Any such computer storage media may be part of computing system 700.

A number of program modules may be stored in one or more of the memory/media devices. For example, a basic input/output system (BIOS 724), containing the basic routines that help to transfer information between elements within the computing system 700, such as during start-up, may be stored in ROM 708. Similarly, RAM 710, hard drive 718, and/or peripheral memory devices may be used to store computer-executable instructions comprising an operating system 726, one or more applications programs 728, other program modules 730, and/or program data 732. Still further, computer-executable instructions may be downloaded to the computing system 700 as needed, for example, via a network connection. The applications programs 728 may include, for example, the pre-processing module 112, auto-labeling module 114, QC module 116, and model training module 132.

An end-user may enter commands and information into the computing system 700 through input devices such as a keyboard 734 and/or a pointing device 736. While not illustrated, other input devices may include a microphone, a joystick, a game pad, a scanner, etc. These and other input devices would typically be connected to the processing unit 702 by means of a peripheral interface 738 which, in turn, would be coupled to bus 706. Input devices may be directly or indirectly connected to processing unit 702 via interfaces such as, for example, a parallel port, game port, firewire, or a universal serial bus (USB). To view information from the computing system 700, a monitor 740 or other type of display device may also be connected to bus 706 via an interface, such as via video adapter 742. In addition to the monitor 740, the computing system 700 may also include other peripheral output devices, not shown, such as speakers and printers.

The computing system 700 may also utilize logical connections to one or more computing system environments. Communications between the computing system 700 and the remote computing system environment may be exchanged via a further processing device, such as a network router 741, that is responsible for network routing. Communications with the network router 741 may be performed via a network interface component 744. Thus, within such a networked environment, e.g., the Internet, wide area network (WAN), local area network (LAN), or other like type of wired or wireless network, it will be appreciated that program modules depicted relative to the computing system 700, or portions thereof, may be stored in the memory storage device(s) of the computing system 700.

The computing system 700 may also include localization hardware 746 for determining a location of the computing system 700. In embodiments, the localization hardware 746 may include, for example, a GPS antenna, an RFID chip or reader, a Wi-Fi antenna, or other computing hardware that may be used to capture or transmit signals that may be used to determine the location of the computing system 700.

While this disclosure has described certain embodiments, it is understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, the subject technology is not limited to the specific details set forth herein and can be practiced using one or more other embodiments. In other instances, well known methods, procedures, components, and circuits have not been described in detail as not to unnecessarily obscure various aspects of the present disclosure. Additionally, in one or more embodiments, structures and components are shown in block diagram form to avoid obscuring the concepts of the subject technology.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It is understood, however, that these terms are to be interpreted as referencing physical manipulations and quantities and are merely convenient labels that should be interpreted further in view of terms commonly used in the art.

Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refers to only A, only B, or only C; any combination of A, B, and C; and/or at least one of any of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation or component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, one or more implementations, one or more implementations, an embodiment, the embodiment, another embodiment, one or more implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any implementation described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Headings and subheadings, if any, are used for convenience only and do not limit the subject disclosure.

What is claimed is:

1. A method comprising:
obtaining an input dataset comprising one or more data points, each data point comprising textual content and contextual information;
generating a first set of coarse-grained labels by processing the input dataset with a first machine learning model configured to assign a coarse-grained label to each of the one or more data points given the textual content and the contextual information of each data point as input;
filtering the input dataset to obtain a subset of the one or more data points that are associated with the coarse-grained label;
generating a first set of fine-grained labels by processing the subset with a second machine learning model configured to assign a fine-grained label to each of the one or more data points of the subset given the textual content and the contextual information of each data point as input, wherein the first set of fine-grained labels and the first set of coarse-grained labels have a hierarchical relationship;
sampling the input dataset to form a sampled dataset, the sampled dataset including fewer data points than the input dataset;
generating a second set of coarse-grained labels and a second set of fine-grained labels by processing the sampled dataset with a third machine learning model configured to assign at least one of a coarse-grained label and a fine-grained label to each of the one or more data points of the sampled dataset based on the textual content and the contextual information of each data point; and
validating accuracy of the first set of coarse-grained labels and the first set of fine-grained labels based on a comparison with the second set of coarse-grained labels and the second set of fine-grained labels for each data point in the sampled dataset.

2. The method of claim 1, wherein obtaining the input dataset comprises:
normalizing the textual content of each data point, wherein each textual content is based on a user interaction associated with a data point; and
generating the contextual information of each data point, wherein the contextual information includes user account activity.

3. The method of claim 1, wherein the first set of fine-grained labels is associated with a set of confidence scores, and sampling the input dataset is based on the set of confidence scores and a predetermined confidence threshold.

4. The method of claim 1, further comprising retraining the second machine learning model using one or more data points of the sampled dataset, the one or more data points having at least one of a first coarse-grained label different than a second coarse-grained label and a first fine-grained label different than a second fine-grained label.

5. The method of claim 1, wherein:
the first machine learning model is a large language model; and
processing the input dataset with the first machine learning model comprises generating a prompt to the first machine learning model that describes a classification task.

6. The method of claim 5, wherein the prompt includes a plurality of positive labels and a negative label, each positive label different from one another and sharing semantic meaning.

7. The method of claim 1, wherein the second machine learning model is a neural network, the neural network including one or more expert models for generating the first set of fine-grained labels, each of the one or more expert models configured to generate a fine-grained label for a particular data type.

8. The method of claim 1, wherein:
the third machine learning model is a large language model; and
processing the sampled dataset with the third machine learning model comprises generating a prompt to the third machine learning model, the prompt including a classification task for generating a coarse-grained label and a fine-grained label for the sampled dataset.

9. The method of claim 1, wherein the first machine learning model includes more parameters than the second machine learning model.

10. The method of claim 1, wherein the third machine learning model includes more parameters than the first machine learning model.

11. The method of claim 1, wherein the hierarchical relationship between the first set of coarse-grained labels and the first set of fine-grained labels is represented as hierarchical label embeddings, and the first set of fine-grained labels is generated by processing the subset with the second machine learning model biased by the hierarchical label embeddings to improve classification accuracy of the second machine learning model.

12. The method of claim 1, wherein the third machine learning model is a separate large language model trained independently from the first machine learning model and the second machine learning model.

13. A computing device comprising:
a processor; and
a non-transitory computer-readable medium storing instructions that, when executed by the processor, cause the computing device to perform operations comprising:
obtaining an input dataset comprising one or more data points, each comprising textual content and contextual information;
labeling one or more data points of the input dataset with a first label by a first machine learning model based on the textual content and the contextual information of each data point;
labeling one or more data points of the labeled data points with a second label by a second machine learning model based on the textual content and the contextual information of each data point;
labeling a subset of the input dataset with at least one of a third label or a fourth label by a third machine learning model based on the textual content and the contextual information of each data point in the subset; and
flagging one or more data points in the input dataset having at least one of a first label different than a third label and a second label different than a fourth label.

14. The computing device of claim 13, wherein each textual content is based on a user interaction associated with a data point, each textual content is normalized for labeling by the first machine learning model, and each contextual information is based on user account activity associated with a data point.

15. The computing device of claim 13, wherein the second label for each of the one or more data points is associated with a confidence score, and the subset of the input dataset includes data points associated with a confidence score below a predetermined confidence score threshold.

16. The computing device of claim 13, wherein the second label has a hierarchical relationship with the first label represented as hierarchical label embeddings, and the second machine learning model is biased by the hierarchical label embeddings to improve classification accuracy of the second machine learning model.

17. The computing device of claim 13, wherein the first machine learning model and the third machine learning model are each large language models and the second machine learning model is a deep neural network.

18. A method comprising:
generating a first set of coarse-grained labels, a first set of fine-grained labels, a second set of coarse-grained labels, and a second set of fine-grained labels, wherein:
the first set of coarse-grained labels are generated by processing an input dataset with a first machine learning model configured to assign a coarse-grained label to each data point of the input dataset based on textual content and contextual information of each data point,
the first set of fine-grained labels are generated by processing labeled data points with a second machine learning model configured to assign a fine-grained label to each labeled data point of the labeled data points based on textual content and contextual information of each labeled data point, and
the second set of coarse-grained labels and the second set of fine-grained labels are generated by processing a subset of the input dataset with a third machine learning model configured to assign at least one of a coarse-grained label or a fine-grained label to each data point of the subset based on textual content and contextual information of each data point; and
validating the subset of the input dataset based on comparisons of the first set of coarse-grained labels with the second set of coarse-grained labels and comparisons of the first set of fine-grained labels with the second set of fine-grained labels.

19. The method of claim 18, further comprising modifying the second machine learning model using one or more data points of the subset, the one or more data points having at least one of a first coarse-grained label different than a second coarse-grained label and a first fine-grained label different than a second fine-grained label.

20. The method of claim 18, further comprising, in response to identifying one or more data points of the subset having at least one of a first coarse-grained label different than a second coarse-grained label and a first fine-grained label different than a second fine-grained label, performing the method on the one or more data points as the input dataset.
